(19) United States
(12) Patent Application Publication
(10) Pub. No.: US 2024/0397166 A1
(43) Pub. Date: Nov. 28, 2024

(54) METHOD, MAINFRAME, SYSTEM AND APPARATUS FOR MONITORING PLAYED CONTENT, MEDIUM AND DEVICE

(71) Applicant: BOE Technology Group Co., Ltd., Beijing (CN)

(72) Inventor: Yanhong Wu, Beijing (CN)

(73) Assignee: BOE Technology Group Co., Ltd., Beijing (CN)

(21) Appl. No.: 18/271,495

(22) PCT Filed: Aug. 31, 2022
(86) PCT No.: PCT/CN2022/116276

§ 371 Date: Jul. 10, 2023

(51) Int. Cl. H04N 21/8352; H04N 21/235; H04N 21/24

(52) U.S. Cl. CPC H04N 21/8352; H04N 21/2353; H04N 21/2404

(57) ABSTRACT

The present disclosure provides a method, mainframe, system and apparatus for monitoring a played content, a medium and a device, which relates to the technical field of communications. The method includes: within a current monitoring time duration, acquiring a displayed-page screenshot from a displaying device, wherein the displayed-page screenshot is obtained by performing screen shooting to a displayed page of the displaying device; extracting a first content identification code from the displayed-page screenshot, wherein the first content identification code is for identifying a to-be-monitored content that is currently played; and based on the first content identification code, determining whether the to-be-monitored content is compliant. The method may be implemented by a playing controlling mainframe, thereby realizing monitoring the content played by the display screen at the edge side.

### TECHNICAL FIELD

The present disclosure relates to the technical field of communications, and particularly relates to a method, mainframe, system and apparatus for monitoring a played content, a medium and a device.

### BACKGROUND

With the rise of the technology of Internet of Things, the MAM system emerges as the times require. The MAM system is extensively applied in scenes such as traffic, finance, market and supermarket. The MAM system usually comprises a displaying device, and the displaying device is used to play specified medium contents, for example, advertisement, movies, television series and sales promotion information.

In the practical usage scenes, it is required to monitor the content displayed by the displaying device. In the related art, the operation managing personnel are required to artificially patrolling-inspect and monitor whether the playing state and the played content of the displaying device are compliant. However, such a mode has the problems of a high cost and a low efficiency.

### SUMMARY

The present disclosure provides a method for monitoring a played content, wherein the method comprises:
within a current monitoring time duration, acquiring a displayed-page screenshot from a displaying device, wherein the displayed-page screenshot is obtained by performing screen shooting to a displayed page of the displaying device;
extracting a first content identification code from the displayed-page screenshot, wherein the first content identification code is for identifying a to-be-monitored content that is currently played; and
based on the first content identification code, determining whether the to-be-monitored content is compliant.

In an alternative example, the step of, based on the first content identification code, determining whether the to-be-monitored content is compliant comprises:
based on the first content identification code, performing first-stage checking, wherein the first-stage checking is for determining whether the to-be-monitored content has an abnormality;
if the first-stage checking is not passed, performing second-stage checking to the displayed-page screenshot, wherein the second-stage checking is for determining an abnormality category of the to-be-monitored content; and
based on a result of the second-stage checking, determining whether the to-be-monitored content is compliant.

In an alternative example, the step of performing second-stage checking to the displayed-page screenshot comprises:
performing frame-abnormality detection to the displayed-page screenshot, to determine whether the to-be-monitored content has an abnormal frame of a first type and/or an abnormal frame of a second type, wherein the first type is a type of screen abnormality, and the second type is a type comprising content abnormality; and
the step of, based on the result of the second-stage checking, determining whether the to-be-monitored content is compliant comprises:
if an abnormal frame of the first type exists, determining that the to-be-monitored content is compliant; and
if an abnormal frame of the second type exists, determining that the to-be-monitored content is non-compliant.

In an alternative example, the step of performing the frame-abnormality detection to the displayed-page screenshot, to determine whether the to-be-monitored content has the abnormal frame of the first type and/or the abnormal frame of the second type comprises:
inputting the displayed-page screenshot into a first detecting model, and according to a result outputted by the first detecting model, determining whether the to-be-monitored content has an abnormal frame of the first type; and/or inputting the displayed-page screenshot into a second detecting model, and according to
a result outputted by the second detecting model, determining whether the to-be-monitored content has an abnormal frame of the second type;
wherein the first detecting model is obtained by training a first neural network by using a plurality of images carrying the screen abnormality as training samples, and the second detecting model is obtained by training a second neural network by using a plurality of images carrying an abnormal content as training samples.

In an alternative example, the step of, if the first-stage checking is not passed, performing the second-stage checking to the displayed-page screenshot comprises:
sending the displayed-page screenshot to a content issuing server, to cause the content issuing server to perform the second-stage checking; and
the step of, based on the result of the second-stage checking, determining whether the to-be-monitored content is compliant comprises:
based on the result of the second-stage checking returned by the content issuing server, determining whether the to-be-monitored content is compliant.

In an alternative example, if it is determined that the to-be-monitored content is non-compliant, the method further comprises at least one of:
shutting down the displaying device, to forbid the displaying device from performing content playing; and/or sending an alarming signal, to indicate that the to-be-monitored content is non-compliant.

In an alternative example, before the step of, within the current monitoring time duration, acquiring the displayed-page screenshot from the displaying device, the method further comprises:
for a predetermined content that is to be sent to the displaying device to be played, generating an identity-code datum corresponding to the predetermined content;
based on the identity-code datum, generating a second content identification code corresponding to the predetermined content; and
sending the predetermined content and the second content identification code to the displaying device, to cause the displaying device to, when playing the predetermined content, exhibit the second content identification code in the displayed page;
wherein the second content identification code serves as a comparison with the first content identification code, for determining whether the to-be-monitored content is compliant.

In an alternative example, the step of, based on the first content identification code, determining whether the to-be-monitored content is compliant comprises:
acquiring a second content identification code corresponding to a to-be-monitored playing time duration, wherein the second content identification code corresponds to a predetermined content that is played within the to-be-monitored playing time duration; and
based on the first content identification code and the second content identification code, determining whether the to-be-monitored content is compliant.

In an alternative example, the step of, based on the first content identification code, determining whether the to-be-monitored content is compliant comprises:
parsing the second content identification code and the first content identification code, to obtain first intermediate data corresponding to the second content identification code and the first content identification code individually, wherein the first intermediate data are intermediate data in a process of converting the identity-code datum corresponding to the content into the content identification code; and
based on the first intermediate data corresponding to the second content identification code and the first content identification code individually, determining whether the to-be-monitored content is compliant;
wherein the first intermediate data are abstracts of the identity-code datum of the played content.

In an alternative example, the second content identification code further comprises a hiding region, the hiding region is for carrying a second intermediate datum corresponding to the identity-code datum, and the step of, based on the first intermediate data corresponding to the second content identification code and the first content identification code individually, determining whether the to-be-monitored content is compliant comprises:
determining whether the first intermediate data corresponding to the second content identification code and the first content identification code individually are totally consistent:
if no, parsing the hiding regions of the second content identification code and the first content identification code, to obtain second intermediate data corresponding to the second content identification code and the first content identification code individually, wherein the second intermediate data are generated before the first intermediate data; and
based on the second intermediate data corresponding to the second content identification code and the first content identification code individually, determining whether the to-be-monitored content is compliant.

In an alternative example, the step of, based on the second intermediate data corresponding to the second content identification code and the first content identification code individually, determining whether the to-be-monitored content is compliant comprises: comparing the two second intermediate data bit by bit;
if the two second intermediate data are totally consistent, determining that the to-be-monitored content is compliant; and
if the two second intermediate data are not totally consistent, determining that the to-be-monitored content is non-compliant.

In an alternative example, if the two second intermediate data are not totally consistent, the method further comprises:
acquiring an inconsistent field of the two second intermediate data, and a content attribute identified by the inconsistent field; and
based on the content attribute identified by the inconsistent field, generating an alarming signal of a corresponding grade, wherein the content attribute comprises at least one of an identifier attribute and a playing-time-duration attribute of the displaying device.

In an alternative example, the step of, based on the identity-code datum, generating the second content identification code of the predetermined content comprises:
performing a plurality of types of encoding iteratively to the identity-code datum, to obtain an intermediate datum for each of the types of encoding; and
mapping a first intermediate datum in the intermediate data corresponding to the plurality of types of encoding to a plurality of checkpoints in a predetermined transparent image, to obtain the second content identification code;
wherein the first intermediate datum is a decimal grayscale datum, and numerical values at different positions in the first intermediate datum correspond to checkpoints at different positions.

In an alternative example, the step of performing the plurality of types of encoding iteratively to the identity-code datum, to obtain the intermediate datum for each of the types of encoding comprises:
performing binary conversion to the identity-code datum;
performing hexadecimal conversion to an intermediate datum obtained by the binary conversion; and
performing decimal conversion to an intermediate datum obtained by the hexadecimal conversion, to obtain the decimal grayscale datum.

In an alternative example, the predetermined transparent image is provided with a datum hiding region, the datum hiding region is for carrying a second intermediate datum corresponding to the identity-code datum, and the method further comprises:
acquiring a second intermediate datum in the intermediate data corresponding to the plurality of types of encoding, wherein the second intermediate datum is generated before the first intermediate datum, and the second intermediate datum is a binary datum; and
based on an encoding value of each of bits in the second intermediate datum, updating a grayscale value of the datum hiding region.

In an alternative example, the step of generating the identity-code datum corresponding to the predetermined content comprises:
acquiring multi-dimensional content attributes of the predetermined content, wherein the multi-dimensional content attributes include one or more of the name of the predetermined content, the playing time duration and the device identifier of the displaying device playing the predetermined content; and
performing duotricemary encoding to the multi-dimensional content attributes individually, to obtain the identity-code datum.

The present disclosure further provides a playing controlling mainframe, wherein the playing controlling mainframe is for implementing the method for monitoring a played content.

The present disclosure further provides a system for monitored playing, wherein the system for monitored playing comprises: a content issuing server, one or more playing controlling mainframes connected to the content issuing server, and displaying devices connected to the playing controlling mainframes individually;
the content issuing server is for sending a to-be-played content to a corresponding instance of the playing controlling mainframes;
the playing controlling mainframe is for sending the to-be-played content to the displaying device, and for implementing the method for monitoring a played content; and the displaying device is for playing the to-be-played content.

On the basis of the same inventive concept, the present disclosure further provides a computer-readable storage medium, wherein a computer program stored in the computer-readable storage medium causes a processor to implement the method for monitoring a played content.

On the basis of the same inventive concept, the present disclosure further provides an electronic device, wherein the electronic device comprises a memory, a processor and a computer program that is stored in the memory and is executable in the processor, and the processor, when executing, implements the method for monitoring a played content.

The present disclosure further provides an apparatus for monitoring a played content, wherein the apparatus comprises:
a screenshot acquiring module, configured for, within a current monitoring time duration, acquiring a displayed-page screenshot from a displaying device, wherein the displayed-page screenshot is obtained by performing screen shooting to a to-be-monitored content that is currently played by the displaying device;
an identification-code acquiring module, configured for extracting a first content identification code from the displayed-page screenshot, wherein the first content identification code is for identifying the played content; and
a verifying module, configured for, based on the first content identification code, determining whether the to-be-monitored content is compliant.

The technical solutions of the embodiments of the present disclosure can, within the current monitoring time duration, acquire the displayed-page screenshot from the displaying device, extract the first content identification code from the displayed-page screenshot, and subsequently, based on the first content identification code, determine whether the to-be-monitored content is compliant.

Because the displayed-page screenshot is obtained by performing screen shooting to the displayed page of the displaying device, and the first content identification code is for identifying a to-be-monitored content that is currently played, it can be determined based on the content identification code what type of content the content that is currently played by the displaying device is, whereby it can be determined based on the first content identification code whether the to-be-monitored content is compliant. In an aspect, it is merely required to perform screen shooting to the displayed page of the displaying device, and the compliance verification on the played content can be performed based on the content identification code extracted from the displayed-page screenshot, whereby no artificial patrolling inspection is required, which reduces the patrolling-inspection cost, and increases the patrolling-inspection efficiency. In another aspect, by using the first content identification code, it can be determined whether the to-be-monitored content is a content specified to be played, and it can be determined whether the playing page of the to-be-monitored content has abnormality, which can increase the accuracy of the patrolling inspection on the played content.

The above description is merely a summary of the technical solutions of the present disclosure. In order to more clearly know the elements of the present disclosure to enable the implementation according to the contents of the description, and in order to make the above and other purposes, features and advantages of the present disclosure more apparent and understandable, the particular embodiments of the present disclosure are provided below.

### BRIEF DESCRIPTION OF THE DRAWINGS

In order to more clearly illustrate the technical solutions of the embodiments of the present disclosure or the related art, the figures that are required to describe the embodiments or the related art will be briefly described below. Apparently, the figures that are described below are embodiments of the present disclosure, and a person skilled in the art can obtain other figures according to these figures without paying creative work. It should be noted that the scales in the drawings are merely illustrative and do not indicate the actual scales.

FIG. 1 schematically shows a schematic diagram of a communication environment applied by a method for monitoring a played content according to the present disclosure;

FIG. 2 schematically shows a schematic flow chart of the steps of a method for monitoring a played content according to the present disclosure:

FIG. 3 schematically shows a schematic flow chart of another method for monitoring a played content according to the present disclosure:

FIG. 4 schematically shows a schematic overall flow chart of a method for monitoring a played content according to the present disclosure:

FIG. 5 schematically shows a schematic diagram of the principle of the conversion of the identity-code datum of the text type into the content identification code of the image type according to the present disclosure:

FIG. 6 schematically shows a schematic diagram of the encoding of an identity-code datum according to an embodiment of the present disclosure:

FIG. 7 schematically shows a schematic whole flow chart of first-stage checking according to the present disclosure:

FIG. 8 schematically shows a schematic whole flow chart of second-stage checking according to the present disclosure:

FIG. 9 schematically shows a schematic diagram of a frame structure of a system for monitored playing according to the present disclosure; and

FIG. 10 schematically shows a schematic structural diagram of an apparatus for monitoring a played content according to the present disclosure.

### DETAILED DESCRIPTION

In order to make the objects, the technical solutions and the advantages of the embodiments of the present disclosure clearer, the technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains on the basis of the embodiments of the present disclosure without paying creative work fall within the protection scope of the present disclosure.

The Media Asset Management (, MAM) system is an overall solution for digitized storage, management and application of various media and contents (for example, video/audio data, text files, and images) based on advanced techniques such as multimedia, network, database and digital storage, and comprises all of the processes, such as collection, cataloging, management, transferring and encoding conversion, of digital media. It mainly serves to satisfy the demands by medium-resource owners on collecting, storing, searching, editing and issuing data, to provide a convenient approach for medium-resource users to access the contents, realize a high-efficiency management of the medium resources, and greatly increase the value of the medium resources.

In the related art, a problem of the service of the MAM system is that, after a content is issued, it is required to monitor whether the side of the displaying device is playing according to a predetermined plan. That is because the displaying device might be invaded by a third party, whereby the displaying device is used by the third party to play illegal contents such as a pornograph-related content, a drug-related content, a politically sensitive content and so on. Certainly, in some circumstances, it is further required to timely monitor whether the displaying device has screen blacking or screen disorder, whether the currently displayed content should be played by the current displaying device, and whether the playing time period of the currently displayed content is correct.

However, currently, the playing monitoring is commonly performed by artificial patrolling inspection, which has a high cost and a low efficiency, and cannot timely deal with emergency situations.

In a processing solution, each of the displaying devices may be provided with a playing monitoring camera, and the playing monitoring camera faces the display screen of the displaying device to shoot, so as to, based on the recorded image, by using techniques such as AI, realize the automatic analysis on the screen content, thereby monitoring the currently displayed contents of the displaying devices. However, such a mode has the following problems.

Firstly, it is required to equip each of the displaying devices with a playing monitoring camera. That does not only increase the cost, but also, when the playing monitoring cameras are being installed, the cameras are required to be installed by following particular standards of the heights, the angles and so on. Furthermore, the operations relevant to the installation of the cameras such as constructing and wiring are restrained in the fields of many clients, and are difficult to practice in the engineering implementation.

Secondly, the automatic analysis on the screen content of the display screen usually requires consuming a large amount of the computing resource, and one MAM system is usually required to monitor as many as tens of or a hundred displaying devices. Obviously, such a mode cannot satisfy the demand on a timely, high-efficiency and low-cost monitoring.

In view of the above, the present disclosure, in order to realize high-efficiency monitoring on the plurality of displaying devices in the MAM system, and reduce the monitoring cost, provides a method for monitoring a played content. The core concept of the method is:

For each of the to-be-played contents, one corresponding content identification code is generated, wherein the content identification code generally uniquely characterizes one played content, and may be displayed at the displayed page and played together with the content. Accordingly, during the monitoring on the played content, screen shooting can be performed to the playing page of the displaying device, and subsequently the content identification code is extracted from the screenshot, whereby, based on the content identification code, it can be determined whether the content that is played by the displaying device is compliant.

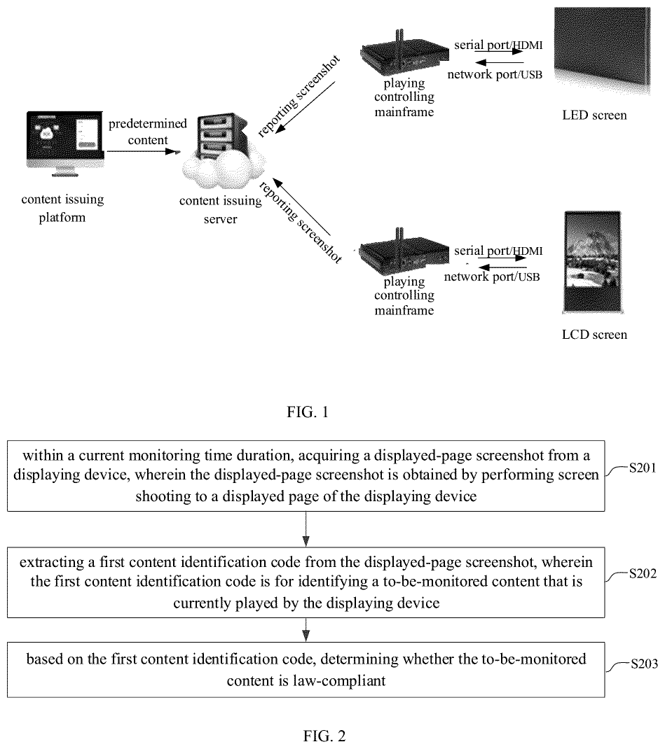

Referring to FIG. 1. FIG. 1 shows a schematic diagram of a communication environment of a MAM system according to the present disclosure. As shown in FIG. 1, the MAM system comprises: a content issuing platform, a content issuing server, a plurality of playing controlling mainframes, and displaying devices connected to the playing controlling mainframes individually. The displaying devices may include an LED display screen, and may also include an LCD display screen. Certainly, in practice they may also include displaying devices of other types, for example, the display screens of terminal devices such as a mobile phone, a computer and a tablet personal computer.

The content issuing server is connected to the plurality of playing controlling mainframes, and each of the playing controlling mainframes may be connected to one or more displaying devices of the same type, or connected to multiple displaying devices of different types.

The playing controlling mainframes and the displaying devices may use serial ports/HDMIs as the downlink channels of the data therebetween, to send the to-be-played contents, and use network ports/USBs as the uplink channels of the data, to receive the displayed-page screenshots uploaded by the displaying devices.

In practical operation, the operating personnel may log in the content issuing platform to issue the to-be-played content, specify the displaying device corresponding to the to-be-played content, and subsequently click to issue. Accordingly, the content issuing platform may send the to-be-played content and the identifier of the displaying device corresponding to the to-be-played content together to the playing controlling mainframe via the content issuing server. Subsequently, the playing controlling mainframe sends the to-be-played content to the corresponding displaying device.

Certainly, in some circumstances, the user, when logging in the content issuing platform to issue the to-be-played content, may also specify the playing time duration of the to-be-played content. In such a case, the content issuing server may also send the playing time duration to the playing controlling mainframe, and the playing controlling mainframe instructs the displaying device to play the to-be-played content at the corresponding playing time duration.

The content according to the present disclosure may refer to multimedia data, for example, advertisement and television programs.

Based on the communication environment shown in FIG. 1, a method for monitoring a played content according to the present disclosure will be described. Referring to FIG. 2. FIG. 2 shows a flow chart of the steps of the method for monitoring a played content according to the present disclosure. The method for monitoring a played content according to the present embodiment may be implemented by the playing controlling mainframes shown in FIG. 1. Certainly, in some other alternative embodiments, the method may also be implemented by the content issuing server, or may be implemented by another terminal device in the MAM system, as long as another terminal device is communicatively connected to the displaying device, and the present disclosure does not particularly limit the mechanism of implementing the method for monitoring a played content.

As shown in FIG. 2, the method mainly comprises the following steps:

Step S201: within a current monitoring time duration, acquiring a displayed-page screenshot from a displaying device, wherein the displayed-page screenshot is obtained by performing screen shooting to a displayed page of the displaying device.

In the present embodiment, the current monitoring time duration may refer to the time duration when the displaying device performs content playing, and, in practice, may refer to the time duration when the displaying device operates. If the displaying device is required to play contents within 10:00-18:00 of a day, then the current monitoring time duration may be the time duration of 10:00-18:00. In such a case, the displayed-page screenshot may be acquired from the displaying device every preset duration interval, to perform the content monitoring at proper time.

Alternatively, in another case, the current monitoring time duration may refer to the time duration within the operating time duration of the displaying device when each of the contents is played. If the displaying device is required to play contents within 10:00-18:00 of a day, wherein the content 1 is played within 10:00-12:00, and the content 2 is played within 12:10-13:00, then the current monitoring time duration may refer to the time duration of the content 1 that is currently played or the time duration of the content 2 that is currently played. In such a case, the displayed-page screenshot may be acquired within all of the playing time durations corresponding to the contents, to monitor the playing of each of the contents.

Among them, within the current monitoring time duration, the displayed-page screenshot may be acquired from the displaying device. In a particular embodiment, a screen-shooting instruction may be sent to the displaying device at any moment of the current monitoring time duration. The displaying device, in response to the screen-shooting instruction, may perform screen shooting to the displayed page of the displaying device, thereby obtaining the displayed-page screenshot. The displaying device, after performing screen shooting to the displayed page to obtain the displayed-page screenshot, may return the displayed-page screenshot to the playing controlling mainframe or the server that sends the screen-shooting instruction.

The displayed page of the screenshot may be the display screen of the displaying device, thereby keeping all of the contents that are displayed currently on the display screen. In some alternative examples, the displayed page of the screenshot may also be a playing window that is playing a content currently in the display screen. In practice, the full screen or the playing window may be screen-shot according to practical situations.

Step S202: extracting a first content identification code from the displayed-page screenshot, wherein the first content identification code is for identifying a to-be-monitored content that is currently played by the displaying device.

In the present embodiment, all of the contents that are required to be played in the displaying device may be generated with one corresponding content identification code in advance, wherein the content identification code may be used to identify the attributes of the played content such as the content identifier, the name, the category and the playing time duration. In practice, the content identification code of one content may be the globally unique identification code, to uniquely characterize the one content. The content identification code may be an identification code of a text type, an identification code of a character-string type or an identification code similar to a two-dimensional code.

In practice, when the content is played in the displaying device, the content identification code may also be displayed in the displayed page of the displaying device. Accordingly, when the displayed page is screen-shot, the content identification code can also be screen-shot when the frame of the played content is screen-shot. Accordingly, when the displayed-page screenshot is obtained, the first content identification code can be extracted from the displayed-page screenshot.

Particularly, when the displaying device is playing the content, the content identification code corresponding to the content may be displayed at a fixed position of the displayed page. The fixed position, according to practical situations, may be an end position of the display screen, and may also be a fixed position in a playing window. Accordingly, no matter whether the displayed page is screen-shot or the playing window of the content is screen-shot, it can be ensured that the displayed-page screenshot has the first content identification code therein.

When the first content identification code is extracted from the displayed-page screenshot, an image of the first content identification code may be extracted from an image region in the displayed-page screenshot that corresponds to the fixed position, and the image of the first content identification code may be parsed, to obtain the first content identification code.

Particularly, if the first content identification code is an identification code of the text type or the character-string type, it may be identified by using the Optical Character Recognition (OCR) technique, to obtain the first content identification code. If it is an identification code of the two-dimensional-code type, an image of the first content identification code may be identified, to obtain the first content identification code that it characterizes.

Step S203: based on the first content identification code, determining whether the to-be-monitored content is compliant.

In the present embodiment, this step may comprise, based on the first content identification code, determining the content identified by the first content identification code, wherein the identified content may be the to-be-monitored content that is currently played by the displaying device. Accordingly, it can be determined based on the first content identification code whether the to-be-monitored content is compliant.

In a case, if the identified-out first content identification code is incomplete, that indicates that the displaying of the displayed page has abnormality, or that may indicate that the displayed page of the displaying device might be invaded by a third party. Accordingly, it can be determined whether the to-be-monitored content is compliant based on whether the first content identification code is incomplete. If it is incomplete, then it is non-compliant. If it is complete, subsequently further monitoring is performed.

In another case, if the identified-out first content identification code is complete, then it may be detected whether the first content identification code has a messy code, wherein the messy code may refer to that the first content identification code contains data that should not appear. In practice, when the displaying device is invaded by a third party, that situation might happen. Accordingly, as long as it is identified that the first content identification code has a messy code, it can be determined that the to-be-monitored content is non-compliant.

In the present disclosure, compliant may refer to that the to-be-monitored content complies with the internal regulation of the platform. The particular regulation may be prescribed by the platform according to demands, for example, prescribed as that the playing time duration of the to-be-monitored content complies with a preset playing time duration, that the to-be-monitored content is a specified played content, that the to-be-monitored content does not contain a frame forbidden played, and so on.

In another case, if the first content identification code is complete and has no messy code, it can be determined that the to-be-monitored content is compliant.

Certainly, in a further example, the content attribute of the to-be-monitored content may continue to be parsed from the first content identification code, wherein the content attribute may include the name, the content identifier and the playing time duration of the content, the identifier of the displaying device, and so on, according to the above embodiments. Accordingly, it may be determined based on the parsed content attribute whether the to-be-monitored content is compliant.

In such a case, if it is determined based on the content attribute that the to-be-monitored content is not a content that should be played within the to-be-monitored playing time duration, or that the identifier of the displaying device corresponding to the to-be-monitored content is not the current displaying device, then it can be determined that the to-be-monitored content is non-compliant. On the contrary, if the to-be-monitored content is the content that should be played within the to-be-monitored playing time duration, or the identifier of the displaying device corresponding to the to-be-monitored content is the current displaying device, then it can be determined that the to-be-monitored content is compliant. Accordingly, the MAM system can further patrolling-inspect the correctness of the content that is currently played by the displaying device, to ensure that the displaying device, within a playing time duration, plays the specified content that should be played within the playing time duration.

By using the technical solution of the present embodiment, in an aspect, it is merely required to perform screen shooting to the currently displayed page of the displaying device, and the compliance verification on the played content can be performed based on the content identification code extracted from the displayed-page screenshot, whereby no artificial patrolling inspection is required, which reduces the patrolling-inspection cost, and increases the patrolling-inspection efficiency. In another aspect, by using the first content identification code, it can be determined whether the to-be-monitored content is a content specified to be played, and it can be determined whether the playing page of the to-be-monitored content has abnormality, which can increase the accuracy of the patrolling inspection on the played content.

In yet another aspect, because it is determined based on the first content identification code in the displayed-page screenshot whether the to-be-monitored content is compliant, wherein the first content identification code generally has a low data volume and thus consumes a few computing resource in the parsing and analysis, a quick and accurate monitoring on the content using data of a low data volume is realized. That prevents the problem in the parsing and analysis on the frame in the displayed-page screenshot relevant to the to-be-monitored content that much computing resource is consumed, the analysis spends a long time, and the accuracy seriously relies on the accuracy of the algorithm (for example, in machine learning, it relies on the quantity of the samples and the design of the neural network).

In an alternative example, if it is determined that the to-be-monitored content is non-compliant, the method may comprise shutting down the displaying device, to forbid the displaying device from performing content playing; or sending an alarming signal, to indicate that the to-be-monitored content is non-compliant; or simultaneously shutting down the displaying device and sending an alarming signal. As stated above, the compliant may also refer to complying with the internal regulation of the platform, and the particular regulation may be prescribed by the platform according to demands.

In the present alternative example, if it is determined according to the first content identification code that the to-be-monitored content is non-compliant, the displaying device may be forcibly shut down. For example, a powering-off signal may be sent to the displaying device, to cut off the power supply of the displaying device, thereby compelling the displaying device to power off, whereby the displaying device is in the off-state, and cannot play the illegal to-be-monitored content. In practice, an alarming signal may be sent to an upper computer and the corresponding user. In the MAM system, the upper computer may be the content issuing platform shown in FIG. 1, and the corresponding user may be a patrolling-inspecting user that patrolling-inspects the displaying device.

The alarming signal may be an alarming message, and it may carry the displayed-page screenshot and the device identifier of the displaying device, to indicate which displaying device is playing the non-compliant content, and the frame of the non-compliant content, thereby facilitating the user to perform further processing to the to-be-monitored content based on the alarming message.

The monitoring means of the played content according to the present disclosure will be described below with reference to the communication environment shown in FIG. 1. Particularly, the monitoring means of the played content according to the present disclosure may comprise the technical means relevant to the monitoring mechanism and the technical means relevant to the data processing. The monitoring mechanism is mainly embodied in the monitoring process for determining whether the to-be-monitored content is compliant. The data processing is mainly embodied in the processing means how to generate the content identification code, and how to monitor based on the content identification code.

The monitoring mechanism and the content processing will be described individually below:

1.1: The Monitoring Mechanism for Determining Whether the to-be-Monitored Content is Compliant

In practice, because, in the present disclosure, it is required to monitor whether the displaying device is used by a third party to play illegal contents such as a pornograph-related content, a drug-related content and other sensitive contents, and it is further required to timely monitor whether the displaying device has screen blacking or screen disorder, whether the currently displayed content should be played by the current displaying device, and whether the playing time period of the currently displayed content is correct, the monitoring task is divided into an abnormality-detection stage of the to-be-monitored content, and a compliance-judgment stage after it is monitored that the to-be-monitored content is abnormal.

The abnormality-detection stage may be based on the detection on the first content identification code, and its purpose is to determine whether the content has displaying abnormality and whether the currently displayed content is the specified content. The compliance-judgment stage may comprise, based on the displayed-page screenshot, for the abnormality detected at the abnormality-detection stage, checking the reason for the abnormality. Particularly, it can be checked whether the reason for the abnormality is a failure in the screen displaying or an invasion by a third party.

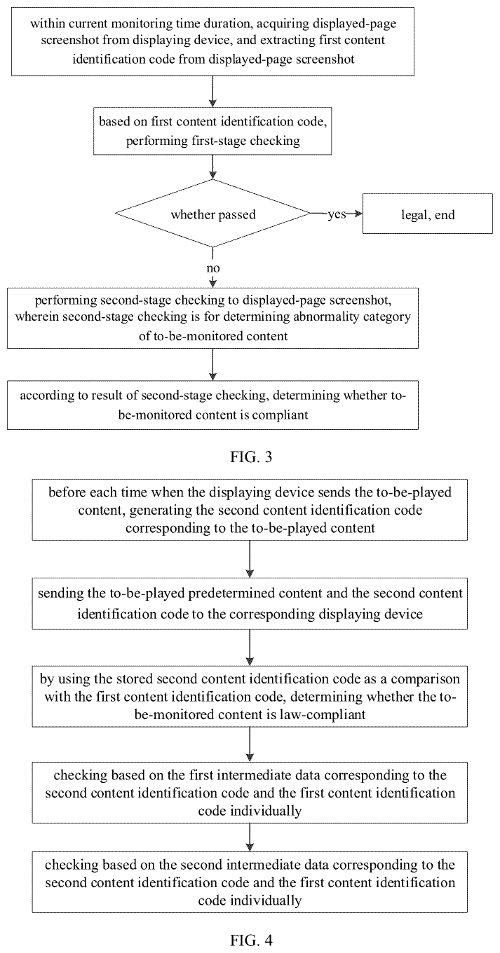

In an alternative example, referring to FIG. 3. FIG. 3 shows a schematic flow chart of another method for monitoring a played content according to the present disclosure. As shown in FIG. 3, the method may particularly comprise the following steps:

S31: within a current monitoring time duration, acquiring a displayed-page screenshot from a displaying device, and extracting a first content identification code from the displayed-page screenshot. The first content identification code is for identifying a to-be-monitored content that is currently played. The displayed-page screenshot is obtained by performing screen shooting to the current screen of the displaying device.

In the present alternative example, this step may comprise, within the playing time duration of each of the contents, acquiring a displayed-page screenshot from a displaying device, so as to, within the playing time durations corresponding to the different contents, monitor the different contents individually, whereby it can be monitored whether, within the playing time durations of the contents, the displaying device correctly plays the contents.

In a particular embodiment, the playing-starting moment and the playing-ending moment of each of the contents may be pre-stored, whereby, within the playing time duration between the playing-starting moment and the playing-ending moment of each of the contents, the displayed-page screenshot is acquired from the displaying device.

The displayed-page screenshot may be obtained by performing screen shooting to the current screen of the displaying device, and it contains the frame of the to-be-monitored content, and also contains the first content identification code.

S32: based on the first content identification code, performing first-stage checking, wherein the first-stage checking is for determining whether the to-be-monitored content has an abnormality.

In the present embodiment, the first-stage checking may be understood as a preliminary checking, and its primary object is to preliminarily check whether the to-be-monitored content is compliant. The process of the first-stage checking may be the process in the step S203 stated above. In other words, it may be determined whether the first content identification code is incomplete, and, if it is incomplete, it can be determined that the to-be-monitored content has abnormality. If it is not incomplete, it may be continuously determined whether the first content identification code has a messy code. If it has a messy code, then the first-stage checking is not passed, which indicates that the to-be-monitored content has abnormality. If it has no messy code, then the content attribute identified by the first content identification code may continue to be parsed, and, based on the content attribute, it is determined whether the to-be-monitored content is within the to-be-monitored playing time duration, and the content that the displaying device should play is specified. If it is determined that the to-be-monitored content is not a content that should be played within the to-be-monitored playing time duration, or that the identifier of the displaying device corresponding to the to-be-monitored content is not the current displaying device, then it can be determined that the to-be-monitored content is abnormal, and the first-stage checking is not passed. If it is contrary, then it is compliant, and the first-stage checking is passed.

In the present alternative example, if the first-stage checking is passed, or, in other words, if it is indicated that the to-be-monitored content is compliant, the monitoring may be ended, and does not enter S33. On the contrary, if the first-stage checking is not passed, or, in other words, if it is indicated that the to-be-monitored content is non-compliant, the process continuously enters S33, and the second-stage checking is performed, to, after checking the reason for the abnormality, finally determine whether the to-be-monitored content is compliant.

S33: performing second-stage checking to the displayed-page screenshot, wherein the second-stage checking is for determining an abnormality category of the to-be-monitored content, and, according to the result of the second-stage checking, determining whether the to-be-monitored content is compliant.

In the present alternative example, the second-stage checking is mainly used to check the abnormality category of the abnormality of the to-be-monitored content, wherein the abnormality category may be understood as the reason for the abnormality of the to-be-monitored content. In practice, because the displayed-page screenshot is obtained by performing screen shooting to the current screen of the displaying device, and it does not only carry the displayed frame of the to-be-monitored content and the first content identification code, but also carries other displayed frames of the current screen, with rich data, this step may comprise, based on the displayed-page screenshot, performing ascription analysis on the abnormality, and, subsequently, based on the analyzed abnormality category, determining whether the to-be-monitored content is compliant.

Particularly, the second-stage checking is exactly the compliance-judgment stage stated above. Particularly, in an alternative example, because the reasons for the abnormality may include a failure in the screen displaying and an invasion by a third party, both of the two types of reasons can be obtained based on the displayed-page screenshot carrying rich data.

In an alternative example, this step may comprise performing frame-abnormality detection to the displayed-page screenshot, to determine whether the to-be-monitored content has an abnormal frame of a first type and/or an abnormal frame of a second type, wherein the first type is a type of screen abnormality, and the second type is a type comprising content abnormality.

Correspondingly, if an abnormal frame of the first type exists, it is determined that the to-be-monitored content is compliant; and if an abnormal frame of the second type exists, it is determined that the to-be-monitored content is non-compliant.

In the present alternative example, the first type is the type of screen abnormality. The screen abnormality may refer to that the display screen of the displaying device has abnormality in the displaying, and is a failure of the software or the hardware of the displaying device. Particularly, it may be determined whether the abnormality of the to-be-monitored content is attributed to the screen abnormality by detecting whether the displayed-page screenshot has a frame of screen blacking and/or screen disorder.

Particularly, if the displayed-page screenshot has a frame of screen blacking, then it can be determined that the abnormality of the to-be-monitored content is attributed to the screen abnormality. If the displayed-page screenshot has a frame of screen disorder, then if the quantity of the frames of screen disorder is greater than a preset quantity, it can be determined that the abnormality of the to-be-monitored content is attributed to the screen abnormality. The displayed-page screenshot has frames of screen blacking and screen disorder, then it is determined that the abnormality of the to-be-monitored content is attributed to the screen abnormality. If the quantity of the frames of screen disorder is not greater than a preset quantity, then the attribution of the abnormality of the to-be-monitored content may be subsequently determined with reference to the result of the detection on the abnormal frames of the second type.

In the present alternative example, the second type is the type of content abnormality. In practice, it may be determined whether the to-be-monitored content has content abnormality based on the frame in the image region in the displayed-page screenshot other than the first content identification code, wherein the content abnormality may refer to frames having a pornograph-related content, a drug-related content or other sensitive contents. In a particular embodiment, the detection on the content abnormality may be realized based on means of machine learning.

As shown in FIG. 3, in the second-stage checking, it may be firstly detected when the displayed-page screenshot has a frame of screen blacking and/or screen disorder, to determine whether the abnormality of the to-be-monitored content is caused by the screen abnormality. If yes, then it can be determined that the abnormality is caused by a failure of the software or the hardware of the displaying device, and is not content abnormality of the currently displayed content, and therefore it can be determined that the to-be-monitored content is compliant. Accordingly, the checking may be ended, and an alarming signal may be sent, to instruct to repair the failure of the software or the hardware of the displaying device.

If the displayed-page screenshot does not have a frame of screen blacking, or has a small quantity of frames of screen disorder, then it is required to further detect whether the displayed-page screenshot has a frame of content abnormality such as a pornograph-related content, a drug-related content or other sensitive contents. If it is found by the detection that there is not a frame of content abnormality, then it is determined that the to-be-monitored content is compliant. If it is found by the detection that there is a frame of content abnormality, then it is determined that the to-be-monitored content is non-compliant. Accordingly, the displaying device may be forcibly shut down, and an alarming signal may be sent, to instruct to enhance the safety protection on the MAM system with respect to the invasion by a third party.

In another alternative example, in the determination on whether the to-be-monitored content has an abnormal frame of the first type, and in the determination on whether the to-be-monitored content has an abnormal frame of the second type, both of the monitoring results may be obtained based on means of machine learning.

Particularly, the means of machine learning may refer to, by using training samples, training a corresponding detecting model in advance, to analyze the displayed-page screenshot by using the detecting model, so as to obtain the result with respect to whether the to-be-monitored content has an abnormal frame of a first type or a second type.

Particularly, the method may comprise inputting the displayed-page screenshot into a first detecting model, and according to a result outputted by the first detecting model, determining whether the to-be-monitored content has an abnormal frame of the first type; and/or, inputting the displayed-page screenshot into a second detecting model, and according to a result outputted by the second detecting model, determining whether the to-be-monitored content has an abnormal frame of the second type; wherein the first detecting model is obtained by training a first neural network by using a plurality of images carrying the screen abnormality as training samples, and the second detecting model is obtained by training a second neural network by using a plurality of images carrying an abnormal content as training samples.

In the present embodiment, the displayed-page screenshot may be firstly inputted into the first detecting model, to determine whether the to-be-monitored content has an abnormal frame of the first type. The result outputted by the first detecting model may be two probability values, which correspond to the category in which an abnormal frame of the first type exists, and the category in which no abnormal frame of the first type exists. In practice, the category corresponding to the higher probability value may be selected as the detection result. As an example, the probability values are 0.8 and 0.2, wherein 0.8 corresponds to the category in which an abnormal frame of the first type exists, and accordingly it can be determined that the detection result is that the to-be-monitored content has an abnormal frame of the first type.

In practice, if the result outputted by the first detecting model indicates that the to-be-monitored content does not have an abnormal frame of the first type, then the displayed-page screenshot may continue to be inputted into the second detecting model, and according to the result outputted by the second detecting model, it is determined whether the to-be-monitored content has an abnormal frame of the second type. Likewise, the result outputted by the second detecting model may be two probability values, which correspond to the category in which an abnormal frame of the second type exists, and the category in which no abnormal frame of the second type exists. In practice, the category corresponding to the higher probability value may be selected as the detection result. As an example, the probability values are 0.7 and 0.4, wherein 0.7 corresponds to the category in which an abnormal frame of the second type exists, and accordingly it can be determined that the detection result is that the to-be-monitored content has an abnormal frame of the second type.

Certainly, if the result outputted by the first detecting model indicates that the to-be-monitored content has an abnormal frame of the first type, then the displayed-page screenshot may continue to be inputted into the second detecting model, and it continues to be determined whether the to-be-monitored content has an abnormal frame of the second type, whereby, according to the result outputted by the second detecting model, it is determined whether the to-be-monitored content has an abnormal frame of the second type. If an abnormal frame of the second type exists, it is determined that the to-be-monitored content is non-compliant. If no abnormal frame of the second type exists, then it is determined that the to-be-monitored content is compliant but it is determined that the displaying device is abnormal.

The training samples of the first detecting model may be sample images containing screen blacking and screen disorder. The second detecting model may, according to the to-be-checked abnormal contents, collect images containing a pornograph-related content, a drug-related content or other sensitive contents as the training samples. The process of training by using the training samples to obtain the first detecting model and the second detecting model may utilize the contents in the related art, which is not discussed further herein.

The first detecting model may be a commonly used classifying model; for example, it may be any one of the models VGG19, Resnet512 and inceptionV3. The second detecting model may also be a commonly used classifying model, for example, any one of VGG19, Resnet512 and inceptionV3. The first detecting model and the second detecting model may be the same one category of model, for example, VGG19, and may also be models of different types.

By training the first detecting model by using the training samples to detect the screen abnormality, and training the second detecting model by using the training samples to detect the content abnormality, the accuracy of the monitoring on the compliance of the to-be-monitored content can be increased by relying on the generalization performance of the models.

As shown in FIG. 1, the method for monitoring a played content according to the present disclosure may be implemented by the playing controlling mainframe. Accordingly, if it is implemented by the playing controlling mainframe, the first-stage checking may be performed by the playing controlling mainframe, and the second-stage checking may be performed by the content issuing server.

Correspondingly, if the first-stage checking is not passed, or, in other words, if it is detected that the to-be-monitored content has abnormality, the playing controlling mainframe may send the displayed-page screenshot to the content issuing server, to cause the content issuing server to perform the second-stage checking. Subsequently, the playing controlling mainframe may receive the result of the second-stage checking returned by the content issuing server, and based on the result of the second-stage checking, determine whether the to-be-monitored content is compliant.

The process of the second-stage checking performed by the content issuing server may refer to the process described in S33 stated above, and is not discussed further herein. The content issuing server, after obtaining the result of the second-stage checking, may send the result of the second-stage checking to the playing controlling mainframe, and subsequently the playing controlling mainframe, based on the result of the second-stage checking, determine whether the to-be-monitored content is compliant. As stated above, if the result of the second-stage checking indicates that an abnormal frame of the second type exists, it is determined that the to-be-monitored content is non-compliant, and the playing controlling mainframe forcibly shuts down the displaying device. If it indicates that no abnormal frame of the second type exists, then it is determined that the to-be-monitored content is compliant.

Certainly, in another alternative example, the content issuing server, after obtaining the result of the second-stage checking, may also not inform the playing controlling mainframe of the result, but directly output the data with respect to whether the to-be-monitored content is compliant, and, if the to-be-monitored content is non-compliant, directly issue to the playing controlling mainframe the instruction of shutting down the displaying, thereby forcibly shutting down the displaying device.

The monitoring mechanism according to the embodiments of the present disclosure has the following advantages:

In an aspect, by using the staged monitoring mechanism of the first-stage checking and the second-stage checking, and if the first-stage checking based on the first content identification code is not passed, subsequently performing the second-stage checking based on the displayed-page screenshot, the first-stage checking and the second-stage checking are based on data of different data volumes. Accordingly, it is not required to perform the global (the displayed-page screenshot and the first content identification code) analysis each time the to-be-monitored content is monitored. Instead, the monitoring is firstly based on the first content identification code of the lower data volume, and if it is not passed, subsequently the analysis is performed based on the displayed-page screenshot of the richer data volume. That prevents consuming the computing resource at a high proportion for a long time while increasing the monitoring efficiency and the monitoring accuracy, thereby increasing the utilization ratio of the computing resource.

In another aspect, because the first-stage checking is performed by the playing controlling mainframe, and the second-stage checking is performed by the content issuing server, the first-stage checking of the lower data volume is performed at the playing controlling mainframe. Because the playing controlling mainframe is directly connected to the displaying device, the MAM system generally has a plurality of playing controlling mainframes, each of the playing controlling mainframes is connected to one or more displaying devices, and the playing controlling mainframes are edge devices, it can be realized that the plurality of edge sides are utilized to monitor the currently displayed contents of the displaying devices at a high efficiency in a dispersed mode, and the dispersive detection prevents the pressure of network concurrency. Moreover, only if the first-stage checking is not passed, the content issuing server performs the second-stage checking of the higher data volume, whereby the accuracy of the preponderant computing resource of the content issuing server can reasonably utilized to determine the compliance. Accordingly, the strategy of graded response facilitates the MAM system to quickly respond, reduces the concurrency pressure of the network, and reduces the pressure of calculation of the content issuing server, to increase the monitoring efficiency of the MAM system.

2.1: The Data Processing in the Process for Determining Whether the to-be-Monitored Content is Compliant

### 2.1.1: The Processing on the First Content Identification Code and the Second Content Identification Code

Because the content identification codes can uniquely identify the played content, when the displayed-page screenshot of the displayed page is acquired from the displaying device, the displayed-page screenshot contains the frame of the currently displayed content. As described in the above embodiments, because, besides it is required to timely monitor whether the displaying device has screen blacking or screen disorder, it is further required to determine whether the currently displayed content should be played by the current displaying device, whether the playing time period of the currently displayed content is correct, and so on, the content identification codes may be used to identify the attributes of the played content such as the name, the playing time duration and the playing displaying device.

In one displaying device, within different playing time durations different contents might be played. Accordingly, when the to-be-monitored content of the displaying device is being monitored based on the first content identification code, the second content identification code corresponding to a predetermined content that is specified to be played within the current playing time duration may be used as a reference, i.e., as a comparison with the first content identification code, to verify whether the to-be-monitored content is the predetermined content specified to be played within the current playing time duration.

In a particular embodiment, before each time when the displaying device sends the to-be-played content, an identity-code datum of the to-be-played content may be generated, wherein the identity-code datum may contain the code of data such as the name of the played content, the playing time duration and the playing displaying device. Accordingly, the second content identification code of each of the to-be-played contents may be obtained based on the identity-code datum, and the second content identification code may be locally stored, so as to subsequently, based on the first content identification code and the second content identification code, determine whether the to-be-monitored content is compliant.

Referring to FIG. 4. FIG. 4 shows a schematic overall flow chart of a method for monitoring a played content according to the present disclosure. As shown in FIG. 4, the method particularly comprises the following steps:

S41: before each time when the displaying device sends the to-be-played content, the second content identification code corresponding to the to-be-played content may be generated, wherein the to-be-played content may be understood as a predetermined content specified to be played by the displaying device.

Particularly, this step may comprise, for the predetermined content to be sent to the displaying device to be played, generating the identity-code datum corresponding to the predetermined content, and subsequently, based on the identity-code datum, generating the second content identification code of the predetermined content.

In the present alternative embodiment, the identity-code datum may be a code having a specified bit quantity that is obtained by encoding the content name, the content identifier, the playing time duration, the identifier of the displaying device and so on, and it may be understood as the identity ID of the predetermined content, wherein the identity-code datum may be associated with the predetermined content and the displaying device playing the predetermined content.

Generally speaking, the identity-code datum may have a specified bit quantity, to reflect the multi-dimensional content attributes of the predetermined content. In an example, the identity-code datum may be obtained by performing duotricemary encoding to the content name, the content identifier, the playing time duration, the identifier of the displaying device and so on; in other words, the identity-code datum may be a duotricemary datum. Certainly, in some other examples, the identity-code datum may also be a hexadecimal datum, which may be determined particularly according to the types and the quantity of the content attributes to be encoded practically. For example, the identity-code datum may be a duotricemary identity datum of 26 bits, and the particular encoding process and generating process of the content identification code will be described in detail in the subsequent section 2.1.2, and are not discussed further herein.

The identity-code datum may be converted into the second content identification code, wherein the conversion process may comprise encrypting the identity-code datum to obtain the second content identification code, or the second content identification code may be a two-dimensional code obtained by encrypting and subsequently converting the identity-code datum. In practice, it is merely required that the identity-code datum can be converted to obtain the second content identification code, and the particular format of the second content identification code is not limited herein, and may particularly refer to the detailed description in the subsequent section 2.1.2.

S42: after the second content identification code is generated, the to-be-played predetermined content may be sent to the corresponding displaying device to be played, and when the to-be-played predetermined content is sent to the corresponding displaying device, the second content identification code may also be sent to the displaying device, to cause the displaying device to, when playing the predetermined content, exhibit the second content identification code in the displayed page. When the displaying device is playing the predetermined content, the second content identification code may be displayed at a fixed position of the screen, as stated above. It may be exhibited at a top-left-corner position, a top-right-corner position, a bottom-left-corner position or a bottom-right-corner-position of the screen, and may also be exhibited at a top-left-corner position, a top-right-corner position, a bottom-left-corner position or a bottom-right-corner-position of the playing window. Preferably, in order not to affect the watching of the predetermined content by the watcher, the second content identification code may be exhibited at the four corners of the screen.

S43: by using the stored second content identification code as a comparison with the first content identification code, determining whether the to-be-monitored content is compliant.

The second content identification code corresponding to the predetermined content and the playing time duration corresponding to the predetermined content may be associate and stored. Accordingly, within one playing time duration, after the first content identification code corresponding to the to-be-monitored content that is currently played by the displaying device is acquired, the stored second content identification code corresponding to the playing time duration may be used as a comparison with the first content identification code, to determine whether the to-be-monitored content is compliant.

Correspondingly, when it is determined whether the to-be-monitored content is compliant based on the first content identification code, this step may comprise acquiring a second content identification code corresponding to a to-be-monitored playing time duration, wherein the second content identification code corresponds to a predetermined content that is played within the to-be-monitored playing time duration; and based on the first content identification code and the second content identification code, determining whether the to-be-monitored content is compliant.

When it is determined by using the second content identification code as a reference whether the to-be-monitored content is compliant, in an alternative example, it may be directly determined whether the to-be-monitored content is compliant based on the first content identification code and the second content identification code; in other words, the subsequent second-stage checking may not be performed, and the result of the first-stage checking is solely based on to determine whether the to-be-monitored content is compliant. In a particular embodiment, the first content identification code and the second content identification code may be compared with respect to whether they are consistent. If they are consistent, that indicates that what the displaying device is playing within the to-be-monitored playing time duration is the predetermined content, and accordingly the to-be-monitored content is compliant. If they are not consistent, that indicates that what the displaying device is playing within the to-be-monitored playing time duration might not be the predetermined content, and accordingly the to-be-monitored content is non-compliant.

Certainly, in another alternative example, in order to prevent false detection, the monitoring mechanism of the cooperation between the first-stage checking and second-stage checking may still be employed. In other words, if the first content identification code and the second content identification code are compared to be inconsistent, the second-stage checking may be performed based on the displayed-page screenshot, to determine whether the to-be-monitored content is compliant.

In the present alternative embodiment, the monitoring may be performed firstly based on the first intermediate data corresponding to the first content identification code and the second content identification code individually. Particularly, based on the first intermediate data corresponding to them individually, it is determined whether the first content identification code and the second content identification code are consistent, and, based on the result with respect to whether they are consistent, it is determined whether the to-be-monitored content is compliant.

S44: the checking based on the first intermediate data corresponding to the second content identification code and the first content identification code individually.

Correspondingly, this step may comprise parsing the second content identification code and the first content identification code, to obtain first intermediate data corresponding to the second content identification code and the first content identification code individually; and based on the first intermediate data corresponding to the second content identification code and the first content identification code individually, determining whether the to-be-monitored content is compliant; wherein the first intermediate data are abstracts of the identity-code datum of the played content.

When it is determined whether the to-be-monitored content is compliant based on the first intermediate data corresponding to the second content identification code and the first content identification code individually, the first intermediate datum of the second content identification code and the first intermediate datum of the first content identification code may be compared with respect to whether they are consistent. If they are consistent, then the to-be-monitored content is compliant. If they are not consistent, then the to-be-monitored content is non-compliant.

In the present embodiment, the first intermediate data are the intermediate data in the process of converting the identity-code datum into the content identification code, and may be understood as the abstract of the identity-code datum. For example, after the identity-code datum passes through the first time of conversion, the second time of conversion, the third time of conversion and even more times of conversion, the content identification code is obtained, and accordingly the first intermediate datum may be the intermediate datum that is obtained by the second time or the third time of conversion. Accordingly, by firstly comparing the first intermediate data, it can be prevented to perform multiple times of reverse conversion to the second content identification code and the first content identification code, thereby increasing the monitoring efficiency.

S45: the checking based on the second intermediate data corresponding to the second content identification code and the first content identification code individually.

Certainly, if the first intermediate data corresponding to the second content identification code and the first content identification code individually are not completely consistent, then, in order for the monitoring accuracy, further verification based on the content identification code may be performed.

Particularly, each of the first content identification code and the second content identification code contains a hiding region, and the hiding region is for carrying a second intermediate datum corresponding to the identity-code datum. Accordingly, it can be determined whether the second intermediate data corresponding to the second content identification code and the first content identification code individually are completely consistent. Both of the second intermediate datum and the first intermediate datum may be an intermediate product in the process of converting the identity-code datum into the content identification code, and the second intermediate datum may be generated before the first intermediate datum. Accordingly, it may be comprehended that the first intermediate datum is generated based on the second intermediate datum. Accordingly, the second intermediate datum may carry more original data, or it may be comprehended that the second intermediate datum is closer to the original identity-code datum. Accordingly, based on the second intermediate datum again, it can be accurately determined whether the to-be-monitored content is compliant.

If the first intermediate data corresponding to the second content identification code and the first content identification code individually are completely consistent, then it is determined that the to-be-monitored content is compliant, and the flow is ended.

If the first intermediate data corresponding to the second content identification code and the first content identification code individually are not completely consistent, the hiding regions of the second content identification code and the first content identification code are parsed, to obtain second intermediate data corresponding to the second content identification code and the first content identification code individually; and based on the second intermediate data corresponding to the second content identification code and the first content identification code individually, it is determined whether the to-be-monitored content is compliant.

In a particular embodiment, the two second intermediate data bit by bit may be compared. If the two second intermediate data are totally consistent, determining that the to-be-monitored content is compliant. If the two second intermediate data are not totally consistent, the second-stage checking may be performed, or it is directly identified as non-compliant, and the flow is ended.

In another alternative example, when it is determined whether the to-be-monitored content is compliant based on the second intermediate datum closer to the identity-code datum, the alarming message of the corresponding grade may be generated based on the inconsistent field of the first content identification code and the second content identification code, to indicate the type of the inconsistency, for example, the inconsistency in the playing time duration, or the inconsistency in the playing displaying device.

In the present alternative example, the different fields of the identity-code datum may be obtained by encoding the different content attributes of the predetermined content; in other words, the different fields characterize the different attributes of the predetermined content, and, for example, the name attribute, the playing-time-duration attribute and the device identifier attribute of the playing device may be embodied in the different fields.

Correspondingly, if the two second intermediate data are not totally consistent, this step may comprise acquiring an inconsistent field of the two second intermediate data, and a content attribute identified by the inconsistent field; and based on the content attribute identified by the inconsistent field, generating an alarming signal of a corresponding grade, wherein the content attribute comprises at least one of an identifier attribute and a playing-time-duration attribute of the displaying device.

In the present embodiment, if the two second intermediate data are not totally consistent, the alarming message of the corresponding grade may be generated based on the content attribute corresponding to the inconsistent field. Particularly, the different content attributes may correspond to alarming of different grades. For example, the identifier attribute of the displaying device may be set to be an alarming of a lower grade, and the playing-time-duration attribute may be set to be an alarming of a higher grade. In practice, the content name may be set to be an alarming of a medium grade, and so on. Certainly, the above is merely illustrative description, and is not a limitation to the present disclosure.

Accordingly, if the alarming signal is a text-type datum, the alarming signal may carry the content attribute corresponding to the inconsistent field, to indicate in what aspect the playing by the displaying device is non-compliant.

Certainly, as a supplementary embodiment, the first content identification code may be directly converted into the identity-code datum of the original code. Accordingly, it may be determined whether the to-be-monitored content is compliant based on the identity-code data corresponding to the first content identification code and the second content identification code individually, i.e., checking based on the original identity-code datum.

If the checking is performed based on the original identity-code datum, in the identity-code datum corresponding to the first content identification code, the second intermediate datum may be extracted directly from the hiding region, and subsequently duotricemary conversion is performed to the binary second intermediate datum, to obtain the original identity-code datum.

When such an embodiment is employed, because the second content identification code can be based on as comparison, to more finely monitor the compliance of the content that is currently played by the displaying device from the dimensions such as the playing time duration and the displaying device, the present disclosure can be applied to MAM systems with an advertisement issuing service, to accurately monitor whether the playing time duration of the advertisement content is correct, and whether the displaying device playing the advertisement content is correct. Moreover, based on the mode of the cooperation between the first-stage checking and the second-stage checking, illegal contents that are played due to an invasion by a third party can be timely found, which increases the efficiency of the content monitoring, and broadens the application scenes of the content monitoring.

### 2.1.2: The Process of Generating the Content Identification Code

As stated above, the content identification code refers to the identification code corresponding to the predetermined content that is required to be displayed by the displaying device, and in order to be distinguished from the first content identification code corresponding to the content that is currently played by the displaying device, the identification code corresponding to the predetermined content is referred to as the second content identification code.

In an alternative example, the content identification code may be an identification code of the image type, and the content identification code may hide the identity-code datum of the currently displayed content by using a color datum in the image. In other words, in a case, the identity-code datum of the text type may be converted into a datum of the image type, to uniquely characterize the text content by using the image. Such a mode may be understood as type conversion of data, i.e., converting the datum from one format type into another format type, wherein the meaning of the datum remains unchanged, thereby realizing a high-level confidentiality of the datum, preventing datum leakage, to maintain the safety of the datum.

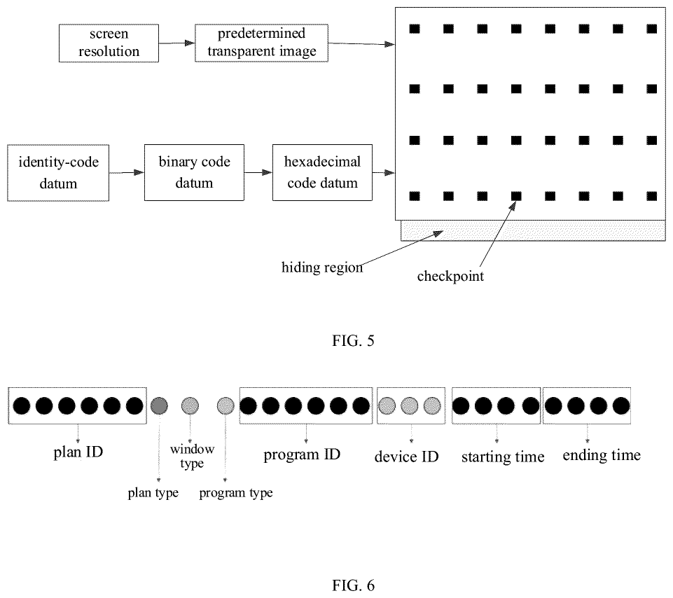

Referring to FIG. 5. FIG. 5 shows a schematic diagram of the principle of the conversion of the identity-code datum of the text type into the content identification code of the image type according to the present disclosure. The process of generating the second content identification code according to the present disclosure will be described with reference to FIG. 5.

Firstly, it is required to generate the identity-code datum. In the present embodiment, the identity-code datum may be obtained by encoding the multi-dimensional content attributes of the predetermined content individually. In a particular embodiment, the method may comprise acquiring multi-dimensional content attributes of the predetermined content; and performing duotricemary encoding to the multi-dimensional content attributes individually, to obtain the identity-code datum of a second predetermined bit quantity. The multi-dimensional content attributes include one or more of the name of the predetermined content, the playing time duration and the device identifier of the displaying device playing the predetermined content.

Referring to FIG. 6. FIG. 6 shows a schematic diagram of the encoding of an identity-code datum according to an embodiment. As shown in FIG. 6, the identity-code datum may be a duotricemary code of 26 bits. The first 0-5 bits represent the name of the content. The 6th bit represents the playing type of the content (the planned type in FIG. 6), wherein the type includes a normal-playing type, a pre-film type and a black screen. The 7th bit represents the type of the windows obtained by segmenting the screen. The window type may be defined and numbered in advance, and may also be self-defined and numbered when making plans. As an example. “1” represents one window. “2” represents two windows that are horizontally distributed. “3” represents two windows that are vertically distributed. “4” represents three windows that are horizontally distributed in one row. “5” represents three windows in two rows with two windows in the first row and one window in the second row. “6” represents three windows in two rows with one window in the first row and two windows in the second row, and “7” represents three windows that are vertically distributed in three rows.

The 8th bit of the identity-code datum is the program type of the content, which is particularly data that may be displayed at medium terminals such as an advertisement video, an advertisement poster, a bus roadmap, a bus schedule and a published notification text. The 9th-14th bits represent the program ID of the content. The 15th-17th bits represent the device ID of the displaying device that will play. The 18th-21th bits represent the starting time when the content starts to be played. The 22nd-25th bits represent the ending time when the playing of the content ends.

When the identity-code datum is converted into the content identification code, as shown in FIG. 5, the following two alternative examples may be selected.

The alternative example 1: mapping the value of each of the bits of the first intermediate datum corresponding to the identity-code datum into the grayscale value of the corresponding checkpoint in the transparent image, to obtain the content identification code.

The alternative example 2: based on the content identification code obtained in the alternative example 1, adding a hiding region in the transparent image, and mapping the second intermediate datum corresponding to the identity-code datum into the hiding region, thereby obtaining the content identification code carrying the two intermediate data.

### 2.1.2.1: The Alternative Example 1.

In a particular embodiment, the method may comprise performing a plurality of types of encoding iteratively to the identity-code datum, to obtain an intermediate datum for each of the types of encoding; and mapping a first intermediate datum in the intermediate data corresponding to the plurality of types of encoding to a plurality of checkpoints in a predetermined transparent image, to obtain the second content identification code.

The first intermediate datum is a decimal grayscale datum, and the numerical values at different positions in the first intermediate datum correspond to checkpoints at different positions.

Referring to FIG. 5, the method may comprise firstly performing binary conversion to the identity-code datum iteratively; subsequently performing hexadecimal conversion to an intermediate datum obtained by the binary conversion; and performing decimal conversion to an intermediate datum obtained by the hexadecimal conversion, to obtain the decimal grayscale datum.

The decimal grayscale datum is the first intermediate datum. The first intermediate datum may have a predetermined bit quantity, for example, a decimal datum of 32 bits, and accordingly the first intermediate datum has 32 numerical values, wherein the value of each of the numerical values is between 0-9. The predetermined transparent image may contain a plurality of checkpoints. The quantity of the checkpoints may be equal to the bit quantity of the first intermediate datum, for example, 32 checkpoints.

Accordingly, the numerical values of the bits of the first intermediate datum can be used as the grayscale values of the checkpoints of the corresponding positions, thereby giving grayscales to the checkpoints in the predetermined transparent image. In such a case, the second content identification code is an image in which there are a plurality of checkpoints, the checkpoints have grayscales and the other regions are transparent.

Because the grayscale values at different positions in the first intermediate datum correspond to the checkpoints at different positions, in practice, the correspondence relation between the numerical values of the bits of the first intermediate datum and the positions of the checkpoints may be specified. As an example, the numerical values from left to right of the first intermediate datum sequentially correspond to the checkpoints from top to bottom and from left to right in the predetermined transparent image. When they are being corresponded, firstly one row of the checkpoints are found according to the from-top-to-bottom position relation, and subsequently the corresponding checkpoint in that row is found in the from-left-to-right sequence.

Certainly, the plurality of checkpoints of the predetermined transparent image may be arranged in an array in the predetermined transparent image, may also be arranged in one column or in one row, and may also be arranged in another shape, which is not limited herein.

The checkpoints may be circular points, or rectangular points, or points of another shape, which is not limited herein.

In the present example, when it is determined whether the to-be-monitored content is compliant based on the first content identification code and the second content identification code, the grayscale values of the checkpoints in the first content identification code and the second content identification code may be parsed individually, and, subsequently, the grayscale values may be combined according to the position correspondence relation between the checkpoints and the bits, thereby reversely parsing the first intermediate datum, so as to, as stated above, based on the two first intermediate data, determine whether the to-be-monitored content is compliant.

### 2.1.2.2: The Alternative Example 2.

As described in the above embodiments, because the content identification code can carry a datum hiding region, when the identity-code datum of the text type is converted into the content identification code of the image type, a hiding region may be provided in the predetermined transparent image, and, subsequently, the datum hiding region is utilized to carry the second intermediate datum corresponding to the identity-code datum.

As shown in FIG. 5, the hiding region may be provided at the lower part of the predetermined transparent image. Certainly. FIG. 5 is merely illustrative description, and in practice, the hiding region may be provided at the upper part, the left side or the right side of the predetermined transparent image.

Correspondingly, the method may comprise acquiring a second intermediate datum in the intermediate data corresponding to the plurality of types of encoding, wherein the second intermediate datum is generated before the first intermediate datum, and the second intermediate datum is a binary datum; and based on an encoding value of each of bits in the second intermediate datum, updating a grayscale value of the datum hiding region.

In the present embodiment, the second intermediate datum may be a datum that is obtained by performing binary conversion to the identity-code datum. For example, the identity-code datum may be encoded by using ASCII, so as to cause each of the characters to contain an 8-bit binary code. Accordingly, each of the bits of 0 and 1 in the binary-coded datum may be used as the grayscale of one small interval within the hiding region, thereby obtaining the hiding region. The small interval may be obtained by delimiting the hiding region according to the bit quantity of the second intermediate datum, and different small intervals correspond to the values of different positions of the second intermediate datum.

As an example, because the identity-code datum is duotricemary, and contains 26 bits of numerical values, and after the identity-code datum is encoded by using ASCII (American Standard Code for Information Interchange), each of the characters contains a 8-bit binary code, the second intermediate datum has 208 bits, and the value of each of the bits is either 0 or 1. Accordingly, the values of the 208 bits may be used sequentially as the grayscale values of the corresponding small intervals of the hiding region.

In such a case, when it is determined whether the to-be-monitored content is compliant based on the second intermediate data corresponding to the first content identification code and the second content identification code individually, the grayscale values of the small intervals of the hiding regions in the first content identification code and the second content identification code may be parsed individually, and, subsequently, the grayscale values may be combined according to the position correspondence relation between the small intervals and the bits, thereby reversely parsing the second intermediate datum, so as to, as stated above, based on the two second intermediate data, determine whether the to-be-monitored content is compliant.

The data processing means according to the embodiments of the present disclosure has the following advantages:

Firstly, because the identity-code datum undergoes various types of encoding conversion to obtain the content identification code, the safety of the content identification code can be improved, whereby the content identification code cannot be easily cracked by a third party, thereby enhancing the safety protection on the patrolling inspection by the MAM system.

Secondly, because the identity-code datum is converted into the content identification code of the image type, the datum is converted from one format type into another format type, wherein the meaning of the datum remains unchanged, thereby realizing a high-level confidentiality of the datum, and further increasing the difficulty in cracking the content identification code.

Thirdly, because the intermediate datum in the process of the conversion of the identity-code datum is hidden in the hiding region, and in the checking, the checking is firstly performed according to the first intermediate datum, and because the first intermediate datum merely requires performing few times of reverse parsing, the monitoring speed is increased. Subsequently, if the checking according to the first intermediate datum is not passed, then the checking is performed according to the second intermediate datum. Because the second intermediate datum is closer to the original identity-code datum, and thus contains a sufficient information amount, the checking according to the second intermediate datum can increase the monitoring accuracy rate, and the playing abnormality of the to-be-monitored content can be accurately found at the stage of the first-stage checking, thereby, while maintaining the monitoring speed, ensuring the monitoring accuracy rate.

Certainly, in practice, after the original identity-code datum is reversely parsed according to the second intermediate datum, the checking may be performed according to the identity-code data corresponding to the first content identification code and the second content identification code individually. Because that is according to the original identity-code datum, the most accurate checking result can be obtained.

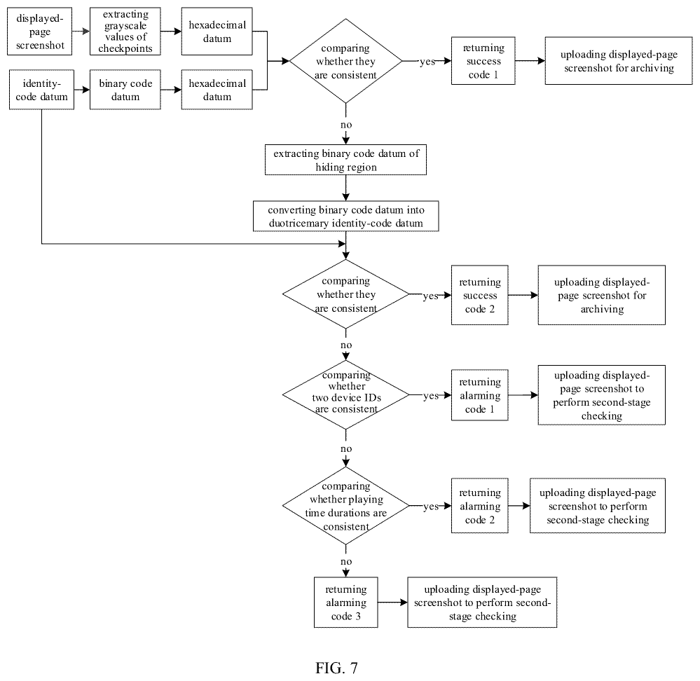

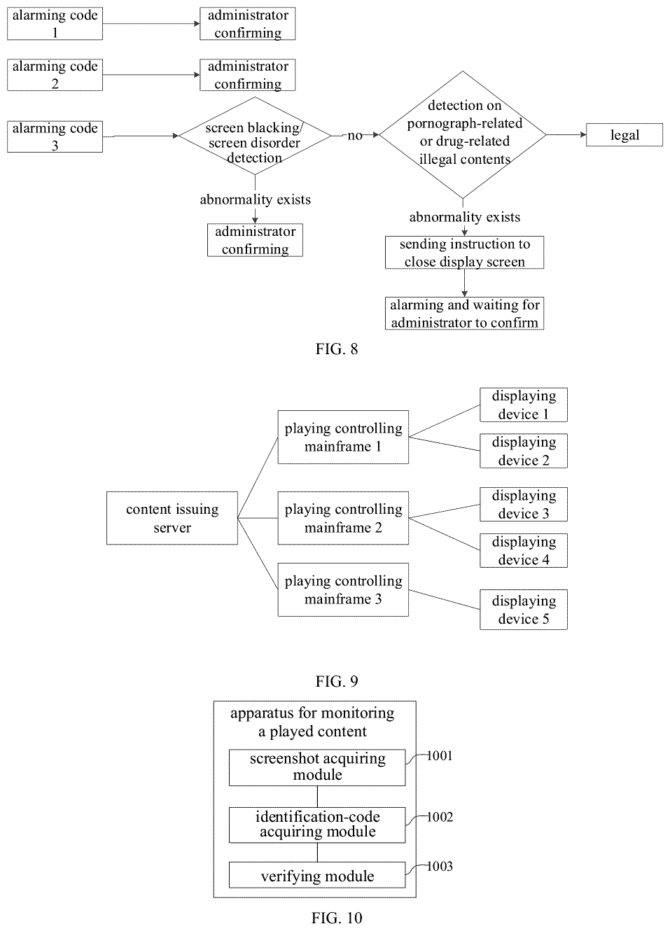

The method for monitoring a played content according to the present disclosure will be illustratively described below with reference to the communication environment shown in FIG. 1 and a particular example. The example illustrates by taking the case as an example in which the to-be-monitored content undergoes the compliance monitoring by using the first-stage checking and the second-stage checking. Referring to FIG. 7, FIG. 7 shows a schematic whole flow chart of the first-stage checking according to the present example. Referring to FIG. 8, FIG. 8 shows a schematic whole flow chart of the second-stage checking according to the present example.

As shown in FIG. 7, the whole process of the first-stage checking is as follows:

S71: by the content issuing server, generating a corresponding content identification code for each of the contents.

This step comprises:
encoding the content name, the playing device, the playing device, the playing starting time, the playing ending time, the playing type and the content type into the identity-code datum shown in FIG. 6; and
subsequently, encoding the identity-code datum by using ASCII, wherein each of the characters contains a 8-bit binary code, to obtain a binary intermediate datum (the second intermediate datum); encoding the binary intermediate datum by using MD5 or SHAI, to generate a 32-bit hexadecimal datum (the first intermediate datum), converting the hexadecimal datum into a decimal grayscale datum, and using the values of the bits in the grayscale datum as the grayscale values of the corresponding checkpoints in the predetermined transparent image; and placing the numerical values of the bits of the second intermediate datum within the datum hiding region as the grayscales.

S72: taking the case as an example in which the LED display screen in FIG. 1 serves as the displaying device, by the playing controlling mainframe, sending a predetermined content 1 and the corresponding content identification code to the LED display screen to be displayed, whereby the LED display screen, when playing the predetermined content 1, displays the content identification code.

S73: within the playing time duration of the predetermined content 1, by the playing controlling mainframe, acquiring the displayed-page screenshot from the LED display screen, extracting the first content identification code from the displayed-page screenshot, and locally acquiring the second content identification code corresponding to the playing time duration.

S74: by the playing controlling mainframe, parsing from the first content identification code the grayscale values of the checkpoints; subsequently, according to the position correspondence relation, combining the grayscale values, to obtain the decimal datum; and subsequently, converting the decimal datum into a hexadecimal datum (the first intermediate datum corresponding to the first content identification code). Likewise, a hexadecimal datum stored in the converting process by the identity code of the predetermined content (the first intermediate datum corresponding to the second content identification code) may be directly acquired.

S75: comparing the two hexadecimal data with respect to whether they are consistent; if they are consistent, ending the flow, outputting a success code 1, and uploading the displayed-page screenshot to the content issuing server for archiving; and if they are not consistent, then continuing to parse the binary intermediate datum (the second intermediate datum) from the hiding region of the first content identification code, and converting the binary intermediate datum back into a duotricemary identity-code datum.

S76: comparing the two identity-code data with respect to whether they are consistent; if they are completely consistent, ending the flow, outputting a success code 2, and uploading the displayed-page screenshot to the content issuing server for archiving; and if they are not consistent, then comparing the two identity-code data bit by bit.

S77: comparing the fields corresponding to the device identifier of the displaying device with respect to whether they are consistent, i.e., comparing the content attributes of the device identifier with respect to whether they are consistent; if they are consistent, then outputting an alarming code 1, uploading the displayed-page screenshot to the content issuing server, and performing the second-stage checking; if they are not consistent, then continuing to compare the fields corresponding to the playing time duration with respect to whether they are consistent, i.e., comparing the content attributes of the playing time duration with respect to whether they are consistent; if they are consistent, then outputting an alarming code 2, uploading the displayed-page screenshot to the content issuing server, and performing the second-stage checking; and if they are not consistent, then outputting an alarming code 3, uploading the displayed-page screenshot to the content issuing server, and performing the second-stage checking.

The grade of the alarming code 1 is lower than the grade of the alarming code 2, and the grade of the alarming code 2 is lower than the grade of the alarming code 3.

As shown in FIG. 8, the whole process of the second-stage checking is as follows:

S81: by the playing controlling mainframe, sending the displayed-page screenshot and the corresponding alarming code to the content issuing server.

S82: by the content issuing server, if the alarming code 1 and the alarming code 2 are detected, directly reporting to the administrator, to cause him to confirm whether the to-be-monitored content is played by the correct displaying device within the correct playing time duration.

S83: by the content issuing server, if the alarming code 3 is detected, firstly performing screen abnormality detection on incomplete playing such as screen blacking and screen disorder, for example, inputting the displayed-page screenshot into the first detecting model, and if the result outputted by the first detecting model is screen blacking/screen disorder/incomplete playing of the screen, and is not consistent with the predicted situation, then reporting the datum to the administrator, to maintain the LED display screen.

S84: after the screen abnormalities such as screen blacking and screen disorder have been excluded, performing detection on pornograph-related, violence-related and sensitive data, for example, inputting the displayed-page screenshot into the second detecting model, wherein the second detecting model can extract keywords by using techniques such as the computer-vision algorithm and OCR, and if the result outputted by the second detecting model is that there are the above illegal contents, then instructing the playing controlling mainframe to directly close the LED display screen, and alarming to the administrator.

S85: after the above abnormalities (screen blacking, screen disorder and illegal contents) are excluded, acquiring the category of the to-be-monitored content, archiving, and reporting to the administrator.

Generally, by using the method for monitoring a played content according to the present disclosure, the safety of the played contents issued by the MAM system to various remote screens (an LCD display screen, an LED display screen and display screens of other types of display terminals) undergoes graded monitoring. The playing controlling mainframes deployed at the edge side firstly perform the first-stage checking, and if the first-stage checking is passed, then directly process correspondingly, and send the processing result to the content issuing server for archiving. If the first-stage checking is not passed, then the displayed-page screenshot is fed back to the content issuing server to perform the more intelligent second-stage checking, so as to make the corresponding decision. By using the strategy of edge calculation and graded checking, the utilization rate of the edge-side devices (the playing controlling mainframes) can be increased. The present disclosure facilitates the monitoring system to quickly respond, reduces concurrency and packet loss of the network, and reduces the pressure of calculation of the content issuing server.

Undoubtedly, the encrypting algorithm SDK and the checking algorithm SDK according to the present disclosure may be deployed in the processor or the memory of any device. The contents issued by the MAM system may also be sent to application terminals such as a mobile phone, a tablet personal computer and a notebook computer. Accordingly, the played contents that are issued by the MAM system to merely the terminals such as a mobile phone, a tablet personal computer and a notebook computer may also undergo the compliance detection.

On the basis of the same inventive concept, the present disclosure further provides a playing controlling mainframe, wherein the playing controlling mainframe is for implementing the method for monitoring a played content.

As shown in FIG. 1, the playing controlling mainframe may be deployed at the edge side of the MAM system, and are directly connected to various types of displaying devices, and one playing controlling mainframe may be connected to one or more displaying devices.

On the basis of the same inventive concept, the present disclosure further provides a system for monitored playing. Referring to FIG. 9. FIG. 9 shows a schematic structural diagram of the system for monitored playing. As shown in FIG. 9, the system for monitored playing comprises: a content issuing server, one or more playing controlling mainframes connected to the content issuing server, and displaying devices connected to the playing controlling mainframes individually:
the content issuing server is for sending a to-be-played content to a corresponding instance of the playing controlling mainframes;
the playing controlling mainframe is for sending the to-be-played content to the displaying device, and for implementing the method for monitoring a played content; and the displaying device is for playing the to-be-played content.

In the present alternative example, the content issuing server may be the background server of the content issuing platform. The content issuing platform may be a web-side application, and may also be a mobile-side application, for example, an APP.

In an alternative example, the playing controlling mainframe may perform the first-stage checking and the second-stage checking according to the above embodiments. In another alternative example, the playing controlling mainframe may perform the first-stage checking according to the above embodiments, and the content issuing server may perform the second-stage checking according to the above embodiments.

FIG. 9 shows a case of three playing controlling mainframes and five displaying devices. In practice, the quantity of the playing controlling mainframes and the quantity of the displaying devices may not be limited by FIG. 9.

On the basis of the same inventive concept, the present disclosure further provides an apparatus for monitoring a played content. Referring to FIG. 10, FIG. 10 shows a schematic structural diagram of the monitoring apparatus according to an embodiment of the present disclosure. As shown in FIG. 10, the apparatus comprises:
a screenshot acquiring module 1001, configured for, within a current monitoring time duration, acquiring a displayed-page screenshot from a displaying device, wherein the displayed-page screenshot is obtained by performing screen shooting to a to-be-monitored content that is currently played by the displaying device;
an identification-code acquiring module 1002, configured for extracting a first content identification code from the displayed-page screenshot, wherein the first content identification code is for identifying the played content; and
a verifying module 1003, configured for, based on the first content identification code, determining whether the to-be-monitored content is compliant.

Optionally, the verifying module 1003 comprises:
a first verifying unit, configured for, based on the first content identification code, performing first-stage checking, wherein the first-stage checking is for determining whether the to-be-monitored content has an abnormality;
a second verifying unit, configured for, if the first-stage checking is not passed, performing second-stage checking to the displayed-page screenshot, wherein the second-stage checking is for determining an abnormality category of the to-be-monitored content; and
a determining unit, configured for, based on a result of the second-stage checking, determining whether the to-be-monitored content is compliant.

Optionally, the second verifying unit is particularly configured for performing frame-abnormality detection to the displayed-page screenshot, to determine whether the to-be-monitored content has an abnormal frame of a first type and/or an abnormal frame of a second type, wherein the first type is a type of screen abnormality, and the second type is a type comprising content abnormality; and
the determining unit is particularly configured for, if an abnormal frame of the first type exists, determining that the to-be-monitored content is compliant; and if an abnormal frame of the second type exists, determining that the to-be-monitored content is non-compliant.

Optionally, the second verifying unit comprises:
a first detecting subunit, configured for inputting the displayed-page screenshot into a first detecting model, and according to a result outputted by the first detecting model, determining whether the to-be-monitored content has an abnormal frame of the first type;
and/or
a second detecting subunit, configured for inputting the displayed-page screenshot into a second detecting model, and according to a result outputted by the second detecting model, determining whether the to-be-monitored content has an abnormal frame of the second type;
wherein the first detecting model is obtained by training a first neural network by using a plurality of images carrying the screen abnormality as training samples, and the second detecting model is obtained by training a second neural network by using a plurality of images carrying an abnormal content as training samples.

Optionally, the second verifying unit comprises:
a sending subunit, configured for sending the displayed-page screenshot to a content issuing server, to cause the content issuing server to perform the second-stage checking; and
the determining unit is particularly configured for, based on the result of the second-stage checking returned by the content issuing server, determining whether the to-be-monitored content is compliant.

Optionally, the apparatus further comprises the following modules:
a shutting-down module, configured for, if it is determined that the to-be-monitored content is non-compliant, shutting down the displaying device, to forbid the displaying device from performing content playing; and/or an alarming module, configured for, if it is determined that the to-be-monitored content
is non-compliant, sending an alarming signal, to indicate that the to-be-monitored content is non-compliant.

Optionally, the apparatus further comprises:
a code-datum generating module, configured for, for a predetermined content that is to be sent to the displaying device to be played, generating an identity-code datum corresponding to the predetermined content;
a content-identification-code generating module, configured for, based on the identity-code datum, generating a second content identification code of the predetermined content; and
a sending module, configured for sending the predetermined content and the second content identification code to the displaying device, to cause the displaying device to, when playing the predetermined content, exhibit the second content identification code in the displayed page;
wherein the second content identification code serves as a comparison with the first content identification code, for determining whether the to-be-monitored content is compliant.

Optionally, the verifying module 1003 comprises:
a second-content-identification-code acquiring unit, configured for acquiring a second content identification code corresponding to a to-be-monitored playing time duration, wherein the second content identification code corresponds to a predetermined content that is played within the to-be-monitored playing time duration; and
a verifying unit, configured for, based on the first content identification code and the second content identification code, determining whether the to-be-monitored content is compliant.

Optionally, the verifying module 1003 comprises:
a parsing unit, configured for parsing the second content identification code and the first content identification code, to obtain first intermediate data corresponding to the second content identification code and the first content identification code individually, wherein the first intermediate data are intermediate data in a process of converting the identity-code datum corresponding to the content into the content identification code; and
a first determining unit, configured for, based on the first intermediate data corresponding to the second content identification code and the first content identification code individually, determining whether the to-be-monitored content is compliant;
wherein the first intermediate data are abstracts of the identity-code datum of the played content.

Optionally, the second content identification code further comprises a hiding region, the hiding region is for carrying a second intermediate datum corresponding to the identity-code datum, and the first determining unit is particularly configured for:
determining whether the first intermediate data corresponding to the second content identification code and the first content identification code individually are totally consistent;
if the first intermediate data corresponding to the second content identification code and the first content identification code individually are not totally consistent, parsing the hiding regions of the second content identification code and the first content identification code, to obtain second intermediate data corresponding to the second content identification code and the first content identification code individually, wherein the second intermediate data are generated before the first intermediate data; and
based on the second intermediate data corresponding to the second content identification code and the first content identification code individually, determining whether the to-be-monitored content is compliant.

Optionally, the step of, based on the second intermediate data corresponding to the second content identification code and the first content identification code individually, determining whether the to-be-monitored content is compliant comprises:
comparing the two second intermediate data bit by bit;
if the two second intermediate data are totally consistent, determining that the to-be-monitored content is compliant; and
if the two second intermediate data are not totally consistent, determining that the to-be-monitored content is non-compliant.

Optionally, the apparatus further comprises:
a content-attribute acquiring module, configured for, if the two second intermediate data are not totally consistent, acquiring an inconsistent field of the two second intermediate data, and a content attribute identified by the inconsistent field; and
an alarming-signal generating module, configured for, based on the content attribute identified by the inconsistent field, generating an alarming signal of a corresponding grade, wherein the content attribute comprises at least one of an identifier attribute and a playing-time-duration attribute of the displaying device.

Optionally, the content-identification-code generating module comprises:
an encoding unit, configured for performing a plurality of types of encoding iteratively to the identity-code datum, to obtain an intermediate datum for each of the types of encoding; and
a first mapping unit, configured for mapping a first intermediate datum in the intermediate data corresponding to the plurality of types of encoding to a plurality of checkpoints in a predetermined transparent image, to obtain the second content identification code;
wherein the first intermediate datum is a decimal grayscale datum, and the grayscale values at different positions in the first intermediate datum correspond to checkpoints at different positions.

Optionally, the encoding unit comprises:
a first converting subunit, configured for performing binary conversion to the identity-code datum;
a second converting subunit, configured for performing hexadecimal conversion to an intermediate datum obtained by the binary conversion; and
a third converting subunit, configured for performing decimal conversion to an intermediate datum obtained by the hexadecimal conversion, to obtain the decimal grayscale datum.

Optionally, the predetermined transparent image is provided with a datum hiding region, the datum hiding region is for carrying a second intermediate datum corresponding to the identity-code datum, and the apparatus further comprises:
a second-intermediate-datum acquiring module, configured for acquiring a second intermediate datum in the intermediate data corresponding to the plurality of types of encoding, wherein the second intermediate datum is generated before the first intermediate datum, and the second intermediate datum is a binary datum; and
a mapping module, configured for, based on an encoding value of each of bits in the second intermediate datum, updating a grayscale value of the datum hiding region.

Optionally, the code-datum generating module comprises:
a content-attribute acquiring unit, configured for acquiring multi-dimensional content attributes of the predetermined content, wherein the multi-dimensional content attributes include one or more of the name of the predetermined content, the playing time duration and the device identifier of the displaying device playing the predetermined content; and
an encoding unit, configured for performing duotricemary encoding to the multi-dimensional content attributes individually, to obtain the identity-code datum of a second predetermined bit quantity.

On the basis of the same inventive concept, the present disclosure further provides a computer-readable storage medium, wherein a computer program stored in the computer-readable storage medium causes a processor to implement the method for monitoring a played content.

On the basis of the same inventive concept, the present disclosure further provides an electronic device, wherein the electronic device comprises a memory, a processor and a computer program that is stored in the memory and is executable in the processor, and the processor, when executing, implements the method for monitoring a played content.

The embodiments of the description are described in the mode of progression, each of the embodiments emphatically describes the differences from the other embodiments, and the same or similar parts of the embodiments may refer to each other.

Finally, it should also be noted that, in the present text, relation terms such as first and second are merely intended to distinguish one entity or operation from another entity or operation, and that does not necessarily require or imply that those entities or operations have therebetween any such actual relation or order. Furthermore, the terms “include”. “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element.

The method, mainframe, system and apparatus for monitoring a played content, the medium and the device according to the present disclosure has been described in detail above. The principle and the embodiments of the present disclosure are described herein with reference to the particular examples, and the description of the above embodiments is merely intended to facilitate to comprehend the method according to the present disclosure and its core concept. Moreover, for a person skilled in the art, according to the concept of the present disclosure, the particular embodiments and the range of application may be varied. In conclusion, the contents of the description should not be understood as limiting the present disclosure.

A person skilled in the art, after considering the description and implementing the invention disclosed herein, will readily envisage other embodiments of the present disclosure. The present disclosure aims at encompassing any variations, uses or adaptative alternations of the present disclosure, wherein those variations, uses or adaptative alternations follow the general principle of the present disclosure and include common knowledge or common technical means in the art that are not disclosed by the present disclosure. The description and the embodiments are merely deemed as exemplary, and the true scope and spirit of the present disclosure are presented by the following claims.

It should be understood that the present disclosure is not limited to the accurate structure that has been described above and shown in the drawings, and may have various modifications and variations without departing from its scope. The scope of the present disclosure is merely limited by the appended claims.

The “one embodiment”, “an embodiment” or “one or more embodiments” as used herein means that particular features, structures or characteristics described with reference to an embodiment are included in at least one embodiment of the present disclosure. Moreover, it should be noted that here an example using the wording “in an embodiment” does not necessarily refer to the same one embodiment.

The description provided herein describes many concrete details. However, it can be understood that the embodiments of the present disclosure may be implemented without those concrete details. In some of the embodiments, well-known processes, structures and techniques are not described in detail, so as not to affect the understanding of the description.

In the claims, any reference signs between parentheses should not be construed as limiting the claims. The word “comprise” does not exclude elements or steps that are not listed in the claims. The word “a” or “an” preceding an element does not exclude the existing of a plurality of such elements. The present disclosure may be implemented by means of hardware comprising several different elements and by means of a properly programmed computer. In unit claims that list several devices, some of those devices may be embodied by the same item of hardware. The words first, second, third and so on do not denote any order. Those words may be interpreted as names.

Finally, it should be noted that the above embodiments are merely intended to explain the technical solutions of the present disclosure, and not to limit them. Although the present disclosure is explained in detail with reference to the above embodiments, a person skilled in the art should understand that he can still modify the technical solutions set forth by the above embodiments, or make equivalent substitutions to part of the technical features of them. However, those modifications or substitutions do not make the essence of the corresponding technical solutions depart from the spirit and scope of the technical solutions of the embodiments of the present disclosure.

1. A method for monitoring a played content, wherein the method comprises:
within a current monitoring time duration, acquiring a displayed-page screenshot from a displaying device, wherein the displayed-page screenshot is obtained by performing screen shooting to a displayed page of the displaying device;
extracting a first content identification code from the displayed-page screenshot, wherein the first content identification code is for identifying a to-be-monitored content that is currently played by the displaying device; and
based on the first content identification code, determining whether the to-be-monitored content is compliant.

2. The method according to claim 1, wherein the step of, based on the first content identification code, determining whether the to-be-monitored content is compliant comprises:
based on the first content identification code, performing first-stage checking, wherein the first-stage checking is for determining whether the to-be-monitored content has an abnormality;
if the first-stage checking is not passed, performing second-stage checking to the displayed-page screenshot, wherein the second-stage checking is for determining an abnormality category of the to-be-monitored content; and
based on a result of the second-stage checking, determining whether the to-be-monitored content is compliant.

3. The method according to claim 2, wherein the step of performing second-stage checking to the displayed-page screenshot comprises:
performing frame-abnormality detection to the displayed-page screenshot, to determine whether the to-be-monitored content has an abnormal frame of a first type and/or an abnormal frame of a second type, wherein the first type is a type of screen abnormality, and the second type is a type comprising content abnormality; and
the step of, based on the result of the second-stage checking, determining whether the to-be-monitored content is compliant comprises:
if an abnormal frame of the first type exists, determining that the to-be-monitored content is compliant; and
if an abnormal frame of the second type exists, determining that the to-be-monitored content is non-compliant.

4. The method according to claim 3, wherein the step of performing the frame-abnormality detection to the displayed-page screenshot, to determine whether the to-be-monitored content has the abnormal frame of the first type and/or the abnormal frame of the second type comprises:
inputting the displayed-page screenshot into a first detecting model, and according to a result outputted by the first detecting model, determining whether the to-be-monitored content has an abnormal frame of the first type; and/or
inputting the displayed-page screenshot into a second detecting model, and according to a result outputted by the second detecting model, determining whether the to-be-monitored content has an abnormal frame of the second type;
wherein the first detecting model is obtained by training a first neural network by using a plurality of images carrying the screen abnormality as training samples, and the second detecting model is obtained by training a second neural network by using a plurality of images carrying an abnormal content as training samples.

5. The method according to claim 2, wherein the step of, if the first-stage checking is not passed, performing the second-stage checking to the displayed-page screenshot comprises:
sending the displayed-page screenshot to a content issuing server, to cause the content issuing server to perform the second-stage checking; and
the step of, based on the result of the second-stage checking, determining whether the to-be-monitored content is compliant comprises:
based on the result of the second-stage checking returned by the content issuing server, determining whether the to-be-monitored content is compliant.

6. The method according to claim 2, wherein if it is determined that the to-be-monitored content is non-compliant, the method further comprises at least one of:
shutting down the displaying device, to forbid the displaying device from performing content playing; and/or
sending an alarming signal, to indicate that the to-be-monitored content is non-compliant.

7. The method according to claim 1, wherein before the step of, within the current monitoring time duration, acquiring the displayed-page screenshot from the displaying device, the method further comprises:
for a predetermined content that is to be sent to the displaying device to be played, generating an identity-code datum corresponding to the predetermined content;
based on the identity-code datum, generating a second content identification code corresponding to the predetermined content; and
sending the predetermined content and the second content identification code to the displaying device, to cause the displaying device to, when playing the predetermined content, exhibit the second content identification code in the displayed page;
wherein the second content identification code serves as a comparison with the first content identification code, for determining whether the to-be-monitored content is compliant.

8. The method according to claim 1, wherein the step of, based on the first content identification code, determining whether the to-be-monitored content is compliant comprises:
acquiring a second content identification code corresponding to a to-be-monitored playing time duration, wherein the second content identification code corresponds to a predetermined content that is played within the to-be-monitored playing time duration; and
based on the first content identification code and the second content identification code, determining whether the to-be-monitored content is compliant.

9. The method according to claim 7, wherein the step of, based on the first content identification code, determining whether the to-be-monitored content is compliant comprises:
parsing the second content identification code and the first content identification code, to obtain first intermediate data corresponding to the second content identification code and the first content identification code individually, wherein the first intermediate data are intermediate data in a process of converting the identity-code datum corresponding to the content into the content identification code; and
based on the first intermediate data corresponding to the second content identification code and the first content identification code individually, determining whether the to-be-monitored content is compliant;
wherein the first intermediate data are abstracts of the identity-code datum of a played content.

10. The method according to claim 9, wherein the second content identification code further comprises a hiding region, the hiding region is for carrying a second intermediate datum corresponding to the identity-code datum, and the step of, based on the first intermediate data corresponding to the second content identification code and the first content identification code individually, determining whether the to-be-monitored content is compliant comprises:
determining whether the first intermediate data corresponding to the second content identification code and the first content identification code individually are totally consistent;
if the first intermediate data corresponding to the second content identification code and the first content identification code individually are not totally consistent, parsing the hiding regions of the second content identification code and the first content identification code, to obtain second intermediate data corresponding to the second content identification code and the first content identification code individually, wherein the second intermediate data are generated before the first intermediate data; and
based on the second intermediate data corresponding to the second content identification code and the first content identification code individually, determining whether the to-be-monitored content is compliant.

11. The method according to claim 10, wherein the step of, based on the second intermediate data corresponding to the second content identification code and the first content identification code individually, determining whether the to-be-monitored content is compliant comprises:
comparing the two second intermediate data bit by bit;
if the two second intermediate data are totally consistent, determining that the to-be-monitored content is compliant; and
if the two second intermediate data are not totally consistent, determining that the to-be-monitored content is non-compliant.

12. The method according to claim 11, wherein if the two second intermediate data are not totally consistent, the method further comprises:
acquiring an inconsistent field of the two second intermediate data, and a content attribute identified by the inconsistent field; and
based on the content attribute identified by the inconsistent field, generating an alarming signal of a corresponding grade, wherein the content attribute comprises at least one of an identifier attribute and a playing-time-duration attribute of the displaying device.

13. The method according to claim 7, wherein the step of, based on the identity-code datum, generating the second content identification code of the predetermined content comprises:
performing a plurality of types of encoding iteratively to the identity-code datum, to obtain an intermediate datum for each of the types of encoding; and
mapping a first intermediate datum in the intermediate data corresponding to the plurality of types of encoding to a plurality of checkpoints in a predetermined transparent image, to obtain the second content identification code;
wherein the first intermediate datum is a decimal grayscale datum, and numerical values at different positions in the first intermediate datum correspond to checkpoints at different positions.

14. The method according to claim 13, wherein the step of performing the plurality of types of encoding iteratively to the identity-code datum, to obtain the intermediate datum for each of the types of encoding comprises:
performing binary conversion to the identity-code datum;
performing hexadecimal conversion to an intermediate datum obtained by the binary conversion; and
performing decimal conversion to an intermediate datum obtained by the hexadecimal conversion, to obtain the decimal grayscale datum.

15. The method according to claim 13, wherein the predetermined transparent image is provided with a datum hiding region, the datum hiding region is for carrying a second intermediate datum corresponding to the identity-code datum, and the method further comprises:
acquiring a second intermediate datum in the intermediate data corresponding to the plurality of types of encoding, wherein the second intermediate datum is generated before the first intermediate datum, and the second intermediate datum is a binary datum; and
based on an encoding value of each of bits in the second intermediate datum, updating a grayscale value of the datum hiding region.

16. A playing controlling mainframe, wherein the playing controlling mainframe is for implementing the method for monitoring a played content according to claim 1.

17. A system for monitored playing, wherein the system for monitored playing comprises: a content issuing server, one or more playing controlling mainframes connected to the content issuing server, and displaying devices connected to the playing controlling mainframes individually;
the content issuing server is for sending a to-be-played content to a corresponding instance of the playing controlling mainframes;
the playing controlling mainframe is for sending the to-be-played content to the displaying device, and for implementing the method for monitoring a played content according to claim 1; and
the displaying device is for playing the to-be-played content.

18. (canceled)

19. A non-transitory computer-readable storage medium, wherein a computer program stored in the computer-readable storage medium causes a processor to implement the method for monitoring a played content according to claim 1.

20. An electronic device, wherein the electronic device comprises a memory, a processor and a computer program that is stored in the memory and is executable in the processor, and the processor, when executing, implements the method for monitoring a played content according to claim 1.

21. The method according to claim 3, wherein if it is determined that the to-be-monitored content is non-compliant, the method further comprises at least one of:
shutting down the displaying device, to forbid the displaying device from performing content playing; and/or
sending an alarming signal, to indicate that the to-be-monitored content is non-compliant.
